(19) United States
(12) Patent Application Publication
(10) Pub. No.: US 2024/0022545 A1
(43) Pub. Date: Jan. 18, 2024

(54) REMOTE MANAGEMENT OF SOFTWARE IN A MULTI-CLOUD SYSTEM

(71) Applicant: VMWARE, INC., Palo Alto, CA (US)

(72) Inventors: Jon COOK, San Jose, CA (US); Velmurugan SUBBURAJ, Bodinayakanur (IN); Takeshi YOSHIZAWA, San Jose, CA (US)

(21) Appl. No.: 17/979,011

(22) Filed: Nov. 2, 2022

(30) Foreign Application Priority Data
Jul. 12, 2022 (IN) 202241039892

(51) Int. Cl. H04L 9/40

(52) U.S. Cl. CPC H04L 63/029

(57) ABSTRACT

An example method of remote access to on-premises software executing in a data center by a cloud service executing in a public cloud includes: sending a request from the cloud service to a connection service executing in the public cloud, the request being for delegated access to the on-premises software in the data center; creating, by cooperation between the connection service and a connection agent executing in a gateway of the data center, a connection over a network between the public cloud and the data center; establishing a first local connection between the cloud service and the connection service; establishing a second local connection between the connection agent and the on-premises software; and exchanging data between the cloud service and the on-premises software over a tunnel comprising the first local connection, the connection over the network, and the second local connection.

### RELATED APPLICATIONS

Benefit is claimed under 35 U.S.C. 119(a)-(d) to Foreign Application Serial No. 202241039892 filed in India entitled “REMOTE MANAGEMENT OF SOFTWARE IN A MULTI-CLOUD SYSTEM”, on Jul. 12, 2022, by VMware, Inc., which is herein incorporated in its entirety by reference for all purposes.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers.

SDDC users move through various business cycles, requiring them to expand and contract SDDC resources to meet business needs. This leads users to employ multi-cloud solutions, such as typical hybrid cloud solutions where the SDDC spans across an on-premises data center and a public cloud. Running applications across multiple clouds can engender complexity in setup, management, and operations. Customers can allow remote access to on-premises applications from the public cloud for purposes of remote diagnosis, remediation, upgrade, patching, and the like. Some multi-cloud solutions employ a dedicated virtual private network (VPN) or other type of private connection between the public cloud and the on-premises data center. This provides a secure communication channel for the remote access of on-premises applications. In other multi-cloud solutions, however, the on-premises data center disallows inbound connections or otherwise does not support such a VPN or private connection. In such environments, a different mechanism is required to provide a secure communication channel for remote access of on-premises applications.

### SUMMARY

In an embodiment, a method of remote access to on-premises software executing in a data center by a cloud service executing in a public cloud includes: sending a request from the cloud service to a connection service executing in the public cloud, the request being for delegated access to the on-premises software in the data center; creating, by cooperation between the connection service and a connection agent executing in a gateway of the data center, a connection over a network between the public cloud and the data center; establishing a first local connection between the cloud service and the connection service; establishing a second local connection between the connection agent and the on-premises software; and exchanging data between the cloud service and the on-premises software over a tunnel comprising the first local connection, the connection over the network, and the second local connection.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a cloud control plane implemented in a public cloud and an SDDC that is managed through the cloud control plane, according to embodiments.

FIG. 2 is a block diagram depicting remote access to on-premises software by a cloud service according to embodiments.

FIG. 3 is a flow diagram depicting a method of remote access to on-premises software by a cloud service according to embodiments.

FIG. 4 is a block diagram depicting remote access to on-premises software by a cloud service according to further embodiments.

FIG. 5 is a flow diagram depicting a method of remote access to on-premises software by a cloud service according to further embodiments.

### DETAILED DESCRIPTION

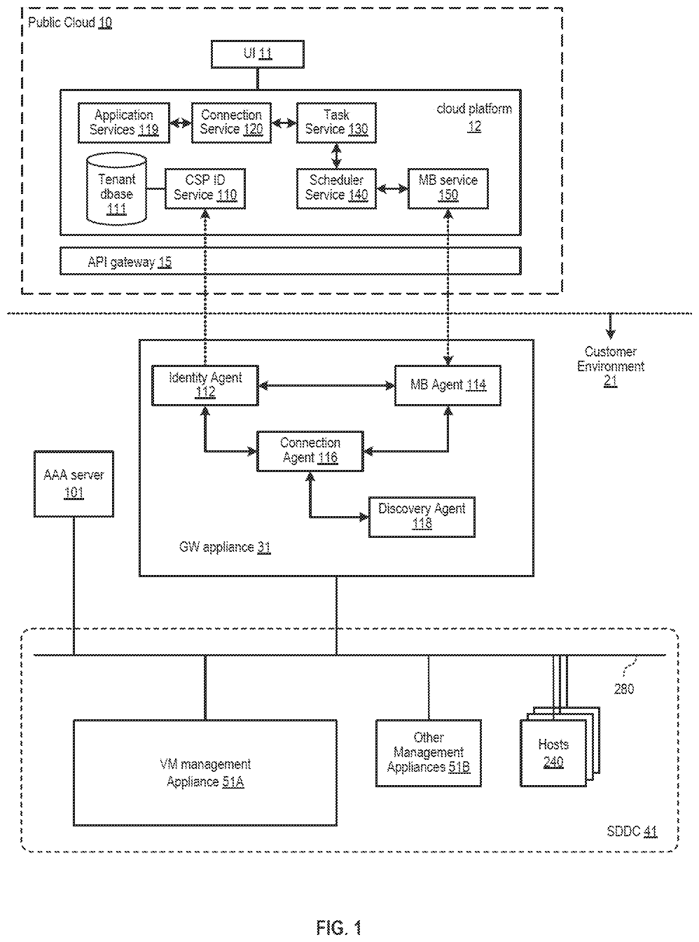

FIG. 1 is a block diagram of customer environments of different organizations (hereinafter also referred to as “customers” or “tenants”) that are managed through a multi-tenant cloud platform 12, which is implemented in a public cloud 10. A user interface (UI) or an application programming interface (API) that interacts with cloud platform 12 is depicted in FIG. 1 1 as UI 11.

An SDDC is depicted in FIG. 1 in a customer environment 21. Although only a single SDDC 41 is shown for simplicity, multi-tenant cloud platform 12 can include multiple SDDCs operated by multiple tenants. In the customer environment, the SDDC is managed by respective virtual infrastructure management (VIM) appliances, e.g., VMware vCenter® server appliance and VMware NSX® server appliance. The VIM appliances in each customer environment communicate with a gateway (GW) appliance, which hosts agents that communicate with cloud platform 12, e.g., via a public network, to deliver cloud services to the corresponding customer environment. For example, the VIM appliances for managing the SDDCs in customer environment 21 communicate with GW appliance 31.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premises, in a public cloud, or as a service, and across different geographical regions.

In the embodiments, the gateway appliance and the management appliances are a VMs instantiated on one or more physical host computers (not shown in FIG. 1) having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, the gateway appliance and the management appliances may be implemented as physical host computers having the conventional hardware platform described above.

FIG. 1 illustrates components of cloud platform 12 and GW appliance 31. The components of cloud platform 12 include a number of different cloud services that enable each of a plurality of tenants that have registered with cloud platform 12 to manage its SDDCs through cloud platform 12. During registration for each tenant, the tenant's profile information, such as the URLs of the management appliances of its SDDCs and the URL of the tenant's AAA (authentication, authorization and accounting) server 101, is collected, and user IDs and passwords for accessing (i.e., logging into) cloud platform 12 through UI 11 are set up for the tenant. The user IDs and passwords are associated with various users of the tenant's organization who are assigned different roles. The tenant profile information is stored in tenant dbase 111, and login credentials for the tenants are managed according to conventional techniques, e.g., Active Directory® or LDAP (Lightweight Directory Access Protocol).

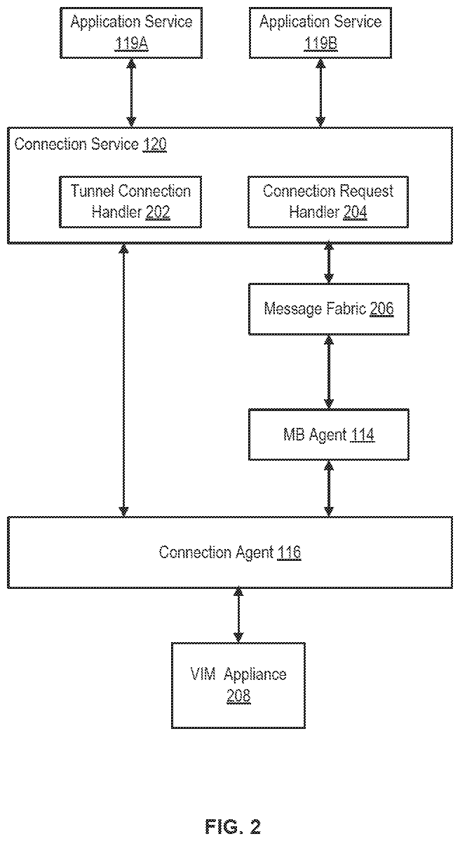

In one embodiment, each of the cloud services is a microservice that is implemented as one or more container images executed on a virtual infrastructure of public cloud 10. The cloud services include a cloud service provider (CSP) identity (ID) service 110, application services 119, a connection service 120, a task service 130, a scheduler service 140, and a message broker (MB) service 150. Similarly, each of the agents deployed in the GW appliances is a microservice that is implemented as one or more container images executing in the gateway appliances. Connection service 120 includes tunnel handling services as discussed further below with respect to FIG. 2.

CSP ID service 110 manages authentication of access to cloud platform 12 through UI 11 or through an API call made to one of the cloud services via API gateway 15. Access through UI 11 is authenticated if login credentials entered by the user are valid. API calls made to the cloud services via API gateway 15 are authenticated if they contain CSP access tokens issued by CSP ID service 110. Such CSP access tokens are issued by CSP ID service 110 in response to a request from identity agent 112 if the request contains valid credentials.

Application services 119 include any type of service through which a user can manage on-premises software, such as a VIM appliance. Remote services 119 can be configured to communicate using various protocols, such as secure shell (SSH), hypertext transfer protocol secure (HTTPS), and the like. Connection service 120 is configured to manage (e.g., create and destroy) reverse encrypted tunnels over standard web-sockets on behalf of remote services for accessing the target on-premises software. The tunnels created by connection service 120 allow for use of tunneled standard protocols, such as SSH and HTTPS, to allow on-premises access from cloud services (e.g., application services 119). The tunnels created by connection service 120 do not require a dedicated VPN between public cloud 10 and SDDC 41. However, while not a dedicated VPN connection, the connection is dedicated to the purpose and duration of the application service requirements.

To manage tunnels, connection service 120 creates tasks and makes API calls to task service 130 to perform the tasks. Task service 130 then schedules the tasks to be performed with scheduler service 140, which then creates messages containing the tasks to be performed and inserts the messages in a message queue managed by MB service 150. After scheduling the tasks to be performed with scheduler service 140, task service 130 periodically polls scheduler service 140 for status of the scheduled tasks.

At predetermined time intervals, MB agent 114, which is deployed in GW appliance 31 in customer environment 21, makes an API call to MB service 150 to exchange messages that are queued in their respective queues (not shown), i.e., to transmit to MB service 150 messages MB agent 114 has in its queue and to receive from MB service 150 messages MB service 150 has in its queue. In the embodiment, messages from MB service 150 associated with connection service 120 are routed to connection agent 116. Connection agent 116 communicates with VIM appliances (e.g., VM management appliance 51A) to create any necessary ephemeral configuration to allow communication over the tunnel. The tunnel itself is established between connection agent 116 and connection service 120 once the ephemeral configuration is established. Tunnel creation is transparent to the VIM appliances. When the tasks are completed by connection agent 116, connection agent 116 invokes an API of scheduler service 140 to report the completion of the task.

Discovery agent 118 communicates with the VIM appliances of SDDC 41 to obtain authentication tokens for accessing the management appliances. In the embodiments, connection agent 116 acquires authentication tokens for accessing the VIM appliances from discovery agent 118 prior to issuing commands to the VIM appliances and includes the authentication tokens in any commands issued to the VIM appliances. In addition to authentication tokens, additional configuration can be performed, such as enabling specific services on the VIM appliances (e.g., secure shell service), creating ephemeral user accounts on the VIM appliances for management, and the like.

FIG. 2 is a block diagram depicting remote access to on-premises software by a cloud service according to embodiments. In the embodiment, application services 119A and 119B (cloud services) access VIM appliance 208 (on-premises software). Remote services 119A and 119B connect to and communicate with connection service 120. Remote service 119A can connect using a first protocol (e.g., SSH) and remote service 119B can connect using a second protocol (e.g., HTTPS). Other types of protocols can be used and in general one or more application services 119 connect to connection service 120.

Connection service 120 includes a tunnel connection handler 202 and a connection request handler 204. Connection request handler 204 interfaces with message fabric 206 to send and receive messages to and from connection agent 116 via MB agent 114. Tunnel connection handler 202 includes local connections with application services 119A and 119B using the designated protocols and ports. Connection agent 116 establishes connection with tunnel connection handler 202, such as a web-socket connection over the Internet. Connection agent 116 cooperates with VIM appliance 208 to prepare VIM appliance 208 for the connection. Remote service 119A and remote service 119B communicates with VIM appliance 208 over the tunnel established by connection service 120 and connection agent 116. Traffic from a remote service is provided to tunnel connection handler 202, sent over the appropriate tunnel, and is then replayed on the target VIM appliance and port. This effectively provides a TCP/UDP connection directly from the remote service to the VIM appliance as if they appear on the same layer 2 network. How the packets are sent via tunnel connection handler 202 and connection agent 116 is determined by routing rule(s) that is/are transferred from connection agent 116 to tunnel connection handler 202.

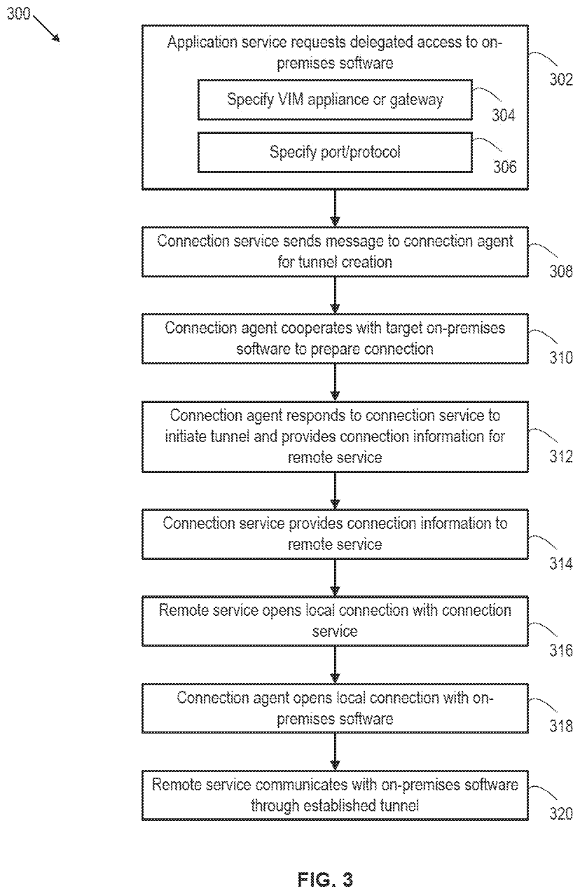

FIG. 3 is a flow diagram depicting a method of remote access to on-premises software by a cloud service according to embodiments. Method 300 can be understood with respect to the components shown in FIG. 2. Method 300 begins at step 302, where a remote service 119 requests delegated access to on-premises software through connection service 120. In embodiments, in the request, remote service 119 specifies a VIM appliance or gateway to access (304), as well as specifies a port/protocol to be used (306). At step 308, connection service 120 sends a message to connection agent 116 through message fabric 206 and MB agent 114 with a task for tunnel creation.

At step 310, connection agent 116 cooperates with the target on-premises software to prepare the connection. For example, connection agent 116 can cooperate with a VIM appliance to enable SSH for an incoming SSH connection from a remote service 119. Connection agent 116 can create ephemeral users and obtain/generate the appropriate credentials to configure the VIM appliance. At step 312, connection agent 116 responds to connection service 120 to initiate the tunnel. Connection agent 116 also provides connection information to connection service 120. The connection information can include, for example, a username and credential for the connection. At step 314, connection service 120 provides the connection information to remote service 119. In embodiments, connection service 120 augments the connection information with additional data, such as an endpoint of connection service to which remote service should connect (e.g., IP address/port information provided to the application service to connect to in the cloud, and IP address/port information of the VIM appliance to wich the local traffic should be tunneled to).

At step 316, remote service 119 opens a local connection with connection service 120 based on the connection information. At step 318, connection agent 116 opens a local connection with the on-premises software. At step 320, remote service 119 communicates with the on-premises software through the tunnel established by connection service 120 and connection agent 116.

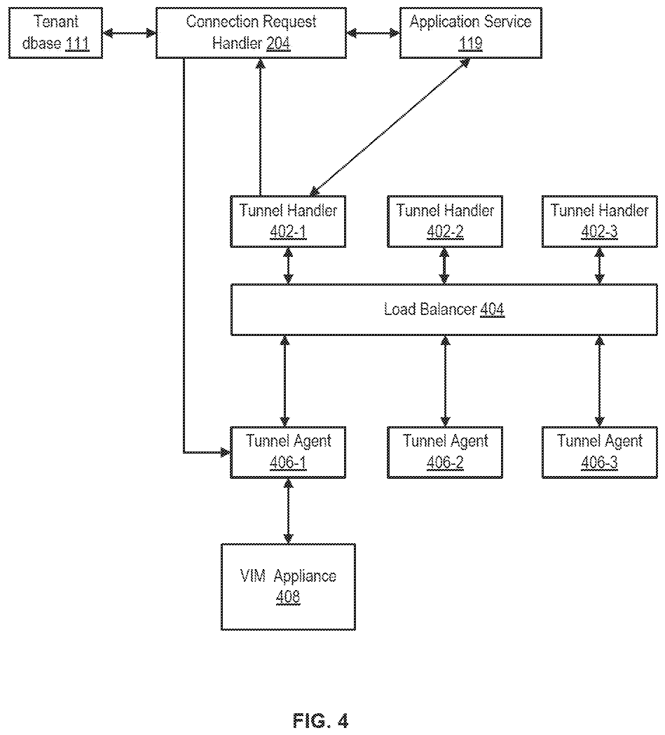

FIG. 4 is a block diagram depicting remote access to on-premises software by a cloud service according to further embodiments. In the present embodiment, tunnel connection handler 202 is a replicated service comprising three instances of tunnel handler 402-1, 402-2, and 402-3 serviced by a load balancer 404. Connection agents 116 in different tenant SDDCs include tunnel agents 406-1, 406-2, and 406-3. A tunnel agent 406 connects with a tunnel handler 402 over a network (e.g., the public Internet) selected by load balancer 404. VIM appliances for other tenants are omitted.

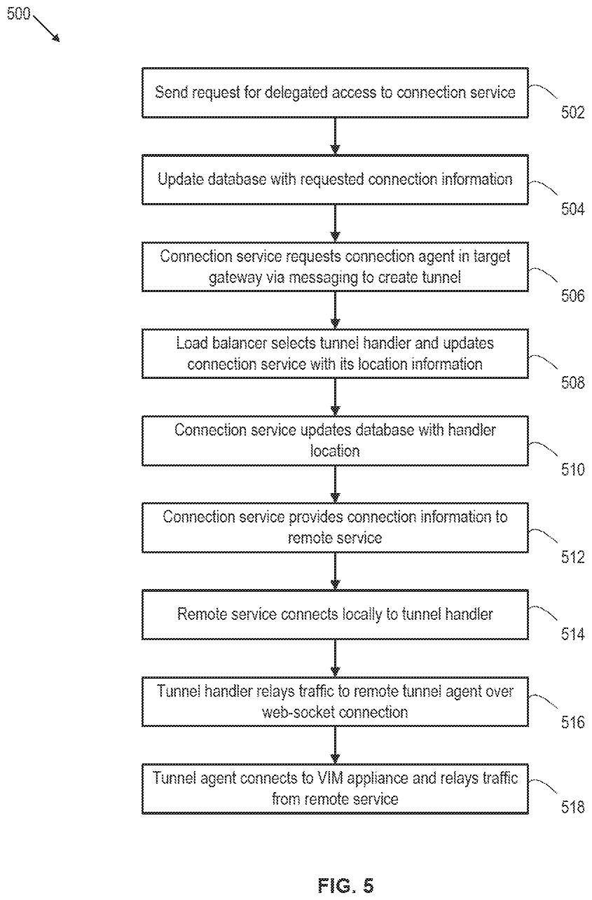

FIG. 5 is a flow diagram depicting a method of according to further embodiments. Method 500 can be understood with respect to the components shown in FIG. 4. Method 500 begins at step 502, where remote service 119 sends a request for delegated access to connection service 120 with a target VIM appliance/gateway and protocol to use for the connection. At step 504, connection service 120 updates tenant dbase 111 with the requested connection information. At step 506, connection service 120 requests connection agent 116 in a target gateway via messaging (as described in method 300 above) to create a tunnel. In this example, connection agent 116 includes tunnel agent 406-1 and connection service 120 interfaces with tunnel agent 406-1 through the messaging framework.

At step 508, load balancer 404 selects a tunnel handler (e.g., tunnel handler 402-1) for connection to tunnel agent 406-1. Tunnel handler 402-1 updates connection service 120 with its location information (e.g., IP address of the tunnel handler that is managing the tunnel that ware requested by the application service). At step 510, connection service 120 updates tenant database 111 with the location information for tunnel handler 402-1. At step 512, connection service 120 provides connection information to remote service 119, including the location information for tunnel handler 402-1. At step 514, remote service 119 connects locally to tunnel handler 402-1. At step 516, tunnel handler 402-1 relays traffic to tunnel agent 406-1 over the web-socket connection. At step 518, tunnel agent 406-1 connects to VIM appliance 408 and relays the traffic from remote service 119. In turn, tunnel agent 406-1 can relay traffic from VIM appliance 408 to tunnel handler 402-1, which in turn relays the traffic back to remote service 119.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of remote access to on-premises software executing in a data center by a cloud service executing in a public cloud, the method comprising:
sending a request from the cloud service to a connection service executing in the public cloud, the request being for delegated access to the on-premises software in the data center;
creating, by cooperation between the connection service and a connection agent executing in a gateway of the data center, a connection over a network between the public cloud and the data center;
exchanging data between the cloud service and the on-premises software over a tunnel comprising the connection over the network.

2. The method of claim 1, wherein the on-premises software comprises a virtual infrastructure management (VIM) appliance executing in the data center.

3. The method of claim 1, wherein the request includes identification information for the on-premises software and a port and protocol for communication.

4. The method of claim 1, wherein the step of creating the connection over the network comprises exchanging messages between the connection service and the connection agent through a messaging fabric.

5. The method of claim 1, wherein the step of creating the connection over the network comprises providing connection information from the connection agent to the connection service and forwarding the connection information from the connection service to the cloud service.

6. The method of claim 5, wherein connection agent establishes the tunnel with the connection service, and wherein the connection service augments the connection information to include location information for a tunnel handler to which the cloud service is to connect.

7. The method of claim 1, wherein the connection over the network comprises a web-socket connection.

8. A non-transitory computer readable medium comprising instructions to be executed in a computing device to cause the computing device to carry out a method of remote access to on-premises software executing in a data center by a cloud service executing in a public cloud, the method comprising:
sending a request from the cloud service to a connection service executing in the public cloud, the request being for delegated access to the on-premises software in the data center;
creating, by cooperation between the connection service and a connection agent executing in a gateway of the data center, a connection over a network between the public cloud and the data center;
exchanging data between the cloud service and the on-premises software over a tunnel comprising the connection over the network.

9. The non-transitory computer readable medium of claim 8, wherein the on-premises software comprises a virtual infrastructure management (VIM) appliance executing in the data center.

10. The non-transitory computer readable medium of claim 8, wherein the request includes identification information for the on-premises software and a port and protocol for communication.

11. The non-transitory computer readable medium of claim 8, wherein the step of creating the connection over the network comprises exchanging messages between the connection service and the connection agent through a messaging fabric.

12. The non-transitory computer readable medium of claim 8, wherein the step of creating the connection over the network comprises providing connection information from the connection agent to the connection service and forwarding the connection information from the connection service to the cloud service.

13. The non-transitory computer readable medium of claim 12, wherein connection agent establishes the tunnel with the connection service, and wherein the connection service augments the connection information to include location information for a tunnel handler to which the cloud service is to connect.

14. The non-transitory computer readable medium of claim 8, wherein the connection over the network comprises a web-socket connection.

15. A virtualized computing system, comprising:
a public cloud in communication with a data center over a network, the public cloud including a cloud service and a connection service executing therein, the data center including on-premises software and a gateway having a connection agent executing therein;
wherein the cloud service is configured to send a request to the connection service for delegated access to the on-premises software;
wherein the connection service is configured to cooperate with the connection agent to create a connection over the network;
wherein the cloud service and the on-premises software exchange data over a tunnel comprising the connection over the network.

16. The virtualized computing system of claim 15, wherein the on-premises software comprises a virtual infrastructure management (VIM) appliance executing in the data center.

17. The virtualized computing system of claim 15, wherein the request includes identification information for the on-premises software and a port and protocol for communication.

18. The virtualized computing system of claim 15, wherein the creating the connection over the network comprises exchanging messages between the connection service and the connection agent through a messaging fabric.

19. The virtualized computing system of claim 15, wherein the creating the connection over the network comprises providing connection information from the connection agent to the connection service and forwarding the connection information from the connection service to the cloud service.

20. The virtualized computing system of claim 19, wherein connection agent establishes the tunnel with the connection service, and wherein the connection service augments the connection information to include location information for a tunnel handler to which the cloud service is to connect.
